(19) United States
(12) Patent Application Publication
(10) Pub. No.: US 2016/0034878 A1
(43) Pub. Date: Feb. 4, 2016

(54) METHOD FOR COMMUNICATING AN ELECTRONIC TRANSACTION BY WAY OF A MOBILE TERMINAL

(71) Applicant: MORPHO, Issy les Molineaux (FR)

(72) Inventors: Naama BAK, Issy les Molineaux (FR); Romain PICON, Issy les Molineaux (FR)

(21) Appl. No.: 14/814,323

(22) Filed: Jul. 30, 2015

(30) Foreign Application Priority Data
Aug. 1, 2014 (FR) 1457545

(51) Int. Cl. G06Q 20/20

(52) U.S. Cl. CPC G06Q 20/202

(57) ABSTRACT

A method is proposed for communicating an electronic transaction between a point of sale (1) and a transaction server (3) by way of a mobile terminal (2) being capable of connecting via an access network (R) for accessing the transaction server (3) via a main communication channel (C2), comprising the steps of:
establishment of a near field communication channel (C1) with the point of sale (1),
production of transaction data intended for the transaction server (3) on the basis of data transmitted by said channel (C1),
verification of the availability of the main channel (C2),
if said main channel (C2) is unavailable, sending of the produced transaction data along a secondary channel (C3) established with the point of sale so that the point of sale (1) can transmit the data to the access network (R).

### GENERAL FIELD

The invention relates to the field of electronic transactions involving a mobile terminal.

The invention more particularly relates to a method for communicating an electronic transaction between a Point of Sale (PoS) and a transaction server by way of a mobile terminal.

### PRIOR ART

In a known manner, an electronic transaction, such as a payment, can be carried out by means of a mobile terminal owned by a user and a device owned by a storekeeper generally designated as the “Point of Sale”, the mobile terminal and the point of sale communicating with each other by near field communication (NFC).

The user of the mobile terminal mobile can thus make a contactless electronic transaction by passing his or her mobile terminal in front of the point of sale.

An authentication element or “secure element” (SE) is used to validate the transaction.

According to a first known type of method, such a secure element is integrated into the mobile terminal, for example in the form of a SIM card.

This first type of method has several drawbacks, however. The SIM card must be capable of implementing the authentication, which necessitates collaboration between the body responsible for the authentication and the SIM card supplier. Moreover, the storage of the secure element in the SIM card limits its updating and sizing options.

A second type of method for carrying out electronic transactions has also been proposed, wherein the secure element is no longer integrated into the mobile terminal but dematerialized “in the cloud”, i.e. in a remote transaction server. The organisation responsible for carrying out the authentication can then perform a check of the secure element without involving a third party, and very easily make changes to the element in a manner transparent to the user of the mobile terminal.

In the context of this second type of method, generally known by the expression “SE in Cloud”, the mobile terminal acts as relay between the point of sale and the transaction server.

However, the mobile terminal must have an operational internet connection so that transaction data can be correctly exchanged by the transaction server and the point of sale. As a consequence, if the Internet connection of the mobile terminal fails, the transaction cannot be completed.

To solve this problem, a method has been proposed wherein the transaction server pre-loads security tokens into the memory of the mobile terminal, against future transactions triggered while the mobile terminal is no longer connected to the Internet and thus to the transaction server. A valid token makes it possible to validate a transaction at the point of sale without having to contacting the transaction server. So, even if the mobile terminal cannot connect to the transaction server, the transaction can be completed.

However, such a security token method has a major security flaw: specifically, a malicious individual can recover these tokens or copy them into another terminal to make fraudulent transactions.

### OVERVIEW OF THE INVENTION

The aim of the invention is to increase the reliability of an electronic transaction benefiting from the advantages of delocalization of a secure element in the cloud, without however impairing the security of such a transaction.

For this purpose, and according to a first aspect, a method is proposed for communicating an electronic transaction between a point of sale and a transaction server by way of a mobile terminal, the mobile terminal being capable of connecting to an access network for accessing the transaction server via a main communication channel, said method comprising the following steps carried out by the mobile terminal:
establishing a near field communication channel with the point of sale,
producing of transaction data intended for the transaction server on the basis of data transmitted by said channel,
verifying of the availability of the main channel,
if said main channel is unavailable, sending of the produced transaction data along a secondary channel established with the point of sale so that point of sale can transmit the data to the access network.

The proposed method allows users to perform transactions with a mobile terminal not connected to the access-giving network, and to do so securely, by clever use of the connection of the point of sale to the access network.

This method has the advantage of being easy to implement in a mobile terminal and a point of sale.

The invention can also be completed by the following features, taken alone or in any of their technical possible combinations.

The main channel being a cellular channel, the mobile terminal can determine its geographical position and selectively send transaction data received along the main channel or a secondary channel established with the point of sale, according to its geographical position.

The method according to the first aspect can comprise the following steps implemented by the point of sale:
establishing of the near field communication channel with the mobile terminal,
sending of primary transaction data along said channel,
establishing of the secondary communication channel with the mobile terminal,
receiving via said secondary channel of secondary transaction data produced and sent by the mobile terminal in response to the primary transaction data,
sending of secondary transaction data received along a pre-established channel between the point of sale and the access network, said channel being independent of the mobile terminal.

The method according to the first aspect can further comprise verifying of the secondary transaction data received via the secondary channel and produced beforehand by the mobile terminal, the sending of data along the channel pre-established between the point of sale and the access network being conditional on the result of the verification.

The two channels established between the mobile terminal and the point of sale can be of near field type.

The two channels between the mobile terminal and the point of sale can be established simultaneously and can form a bi-directional channel.

The secondary channel established between the mobile terminal and the point of sale can be of WiFi type.

According to a second aspect, a mobile terminal is also proposed, comprising:
a first communication interface capable of establishing a near field communication channel with a point of sale,
a second wireless communication interface capable of establishing a main communication channel with an access network for accessing a transaction server,
a third communication interface for establishing a secondary communication channel with the point of sale,
a unit for processing electronic transaction data configured to:
   produce transaction data on the basis of data received via the first interface,
   verify the availability of the main channel,
   if the second channel is unavailable, send the transaction data produced to the third interface for the purpose of being transmitted by the point of sale to the access network.

According to a third aspect, a point of sale is proposed comprising:
a first communication interface capable of establishing a near field communication channel with a mobile terminal,
a second communication interface capable of establishing a communication channel with an access network for accessing a transaction server,
a third communication interface capable of establishing a secondary communication channel with the mobile terminal,
a data processing unit configured to transmit electronic transaction data intended for the transaction server sent via the first interface, then received in return via the second interface, to the third interface.

The third communication interface can be of near field type.

According to a fourth aspect, a computer program product is proposed comprising code instructions for executing steps of a method according to the first aspect, when this program product is executed by a mobile terminal.

According to a fifth aspect, a computer program product is proposed comprising code instructions for executing steps of a method according to the first aspect, when this program product is executed by a point of sale.

### DESCRIPTION OF THE FIGURES

Other features, aims and advantages of the invention will become apparent from the following description, which is purely illustrative and non-limiting, and which must be read with reference to the appended figures.

FIG. 1 represents various items of equipment used in the course of a method for communicating an electronic transaction, according to an embodiment of the invention.

FIG. 2 illustrates the steps of a method for communicating an electronic transaction according to an embodiment of the invention.

In all the figures, similar elements bear identical reference numbers.

### DETAILED DESCRIPTION OF THE INVENTION

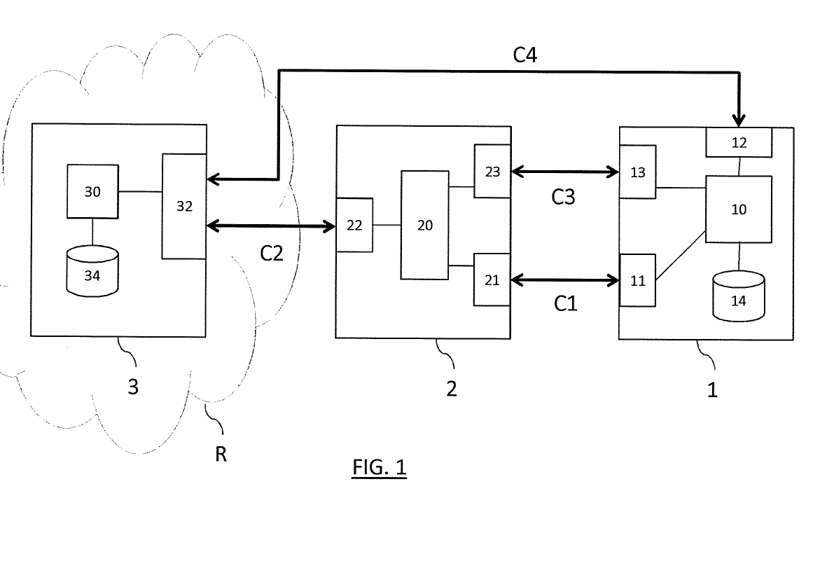

With reference to FIG. 1, a system for carrying out electronic transactions comprises a point of sale 1, a mobile terminal 2 and a transaction server 3.

The point of sale 1 is a device comprising a first communication interface 11, a second communication interface 22, a third communication interface 23, and a unit 10 for processing electronic transaction data.

The communication interface 11 is capable of establishing a first near field communication (NFC) channel with the mobile terminal 2.

The wireless communication interface 13 is also capable of establishing a communication channel with the mobile terminal 2. It can be of various types: the near field type like the interface 11, the Bluetooth® type, or the WiFi type.

If the interface 13 is of the near field type, both interfaces 11 and 13 can be embedded in one and the same NFC chip incorporated into the point of sale 1. In particular, the two interfaces 11 and 13 can be merged and adapted to establish a bi-directional communication channel (full duplex) with the mobile terminal 2.

Moreover, the communication interface 12 is capable of establishing a connection to an access network R giving access to the transaction server. In the remainder of the text the non-limiting example of the Internet network will be chosen. This interface can typically be of the wired (Ethernet) or wireless (3G, 4G, WiFi, etc.) type.

The data processing unit 10 is capable of receiving and/or sending transaction data to/from the communication interfaces 11, 12 and 13 of the point of sale.

The data processing unit 10 is moreover configured to initiate an electronic transaction, and in particular to exchange data relating to such a transaction with the transaction server 3, as will be seen below, by means of a computer program stored in memory by the storage means 14 and executable by the processing unit 10.

The point of sale 1 also comprises storage means 14. These storage means 14 can comprise one or more non-volatile memories of flash, SSD and/or hard disk type, permanently integrated and/or appearing in the form of a removable key such as a USB key.

The point of sale 1 is typically owned by a storekeeper and located in a store. The transactions he or she carries out can be payments for example.

The mobile terminal 2 also comprises three communication interfaces 21, 22, 23 and an electronic data processing unit 20.

The communication interface 21 is of the same type as the interface 11 of the point of sale.

The communication interface 23 is of the same type as the interface 13 of the point of sale.

If the interface 23 is of near field type, the two interfaces 21 and 23 can be embedded in one and the same NFC chip included in the mobile terminal 2. In particular, the two interfaces 21 and 23 can be merged and adapted to establish a bi-directional (full duplex) communication channel with the point of sale 1.

The communication interface 22 is capable of establishing a connection to the access network giving access to the transaction server, and hence independent from the point of sale. This interface is of the wireless (Wifi) or cellular (3G, 4G or derivatives) type.

The data processing unit 20 is capable of receiving and/or sending electronic transaction data to/from the communication interfaces of the terminal, by means of a dedicated computer program.

More specifically, the processing unit 20 can employ various software components: an operating system such as Android®, an HCE component configured to control the interfaces 21 and 23, and a high-level application.

The high-level application is configured to control the interfaces 22 and 23 for the purpose of a dialogue with the transaction server 3.

The high-level application of the mobile terminal is configured to verify the connectivity of the mobile terminal, format replies to the commands received, and process security tokens used in the context of a transaction.

The mobile terminal 2 is an item of personal equipment owned by a user, for example a mobile terminal, a smartphone or a tablet.

The transaction server 3 is capable of implementing a check of a transaction in which the point of sale 1 is participating and more generally allows the completion of the transaction (generation of cryptographic keys, authentication, etc.) depending on the application desired by the service provider (payment, ticketing).

The transaction server 3 further comprises a communication interface 32, an electronic data processing unit 30, and storage means 34.

The storage means 34 can be of one or more types already mentioned as the storage means 14 of the point of sale 1.

The storage means 34 store a computer program constituting a secure element that is virtual within the meaning of NFC transactions.

Such a computer program, known per se, will not be further detailed below; it is enough to recall that this secure computer program implements processing steps making it possible to validate or not validate a transaction in which the point of sale 1 participates.

For example, this computer program provides an authentication function for a transaction initiated by the point of sale 1.

This program can however execute other tasks such as the generation of cryptographic keys, according to the application desired by the service provider.

The transaction server 3 can for example be hosted by a banking institution and dedicated to the validation of a payment initiated by the point of sale 1: the transaction server 3 is then a payment validation server.

The transaction server 3 can further be used as a ticketing server.

The data processing unit 30 is capable of implementing this secure computer program.

The communication interface 32 is accessible from the interfaces 22 and 12 via the network R. The communication interface typically possesses a public IP address known to the mobile terminal.

It will be understood that the interface 32 can be geographically remote from the interfaces 12 and 22, and that these interfaces can be of different types.

Typically, the interfaces 12 and 22 are provided to connect to equipment serving as access points to the network R, and not to connect directly to the transaction server 3. As a consequence, the communication channel between the interface 32 and any one of the interfaces 12 and 22 can be formed by several channels of different types, insofar as they use such access points.

We will simply admit that the interface 12 can exchange data with the interface 32 without involving the interface 22, and that the interface 22 can exchange data with the interface 32 without involving the interface 12.

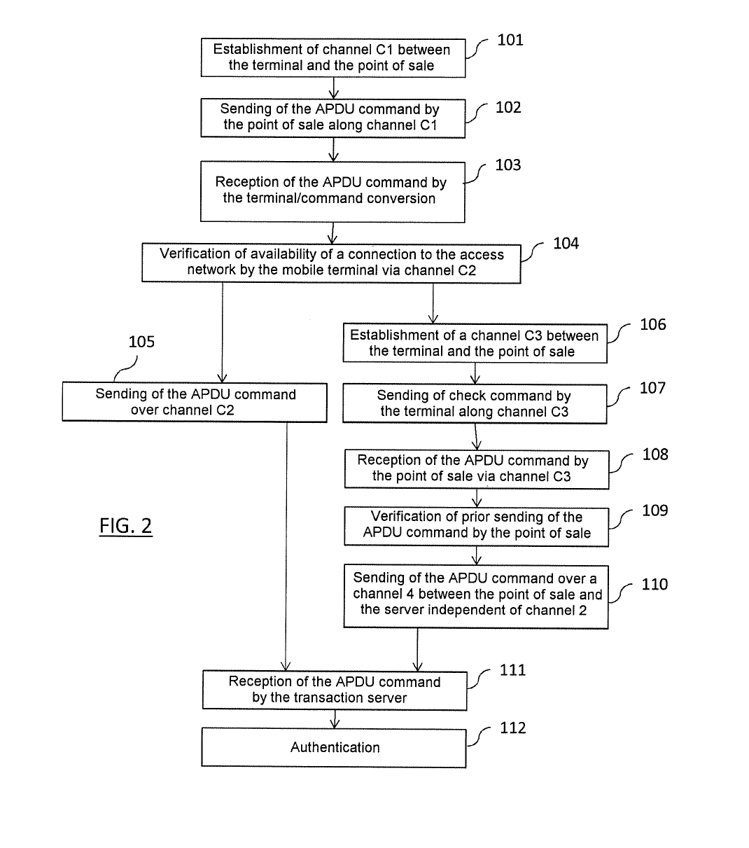

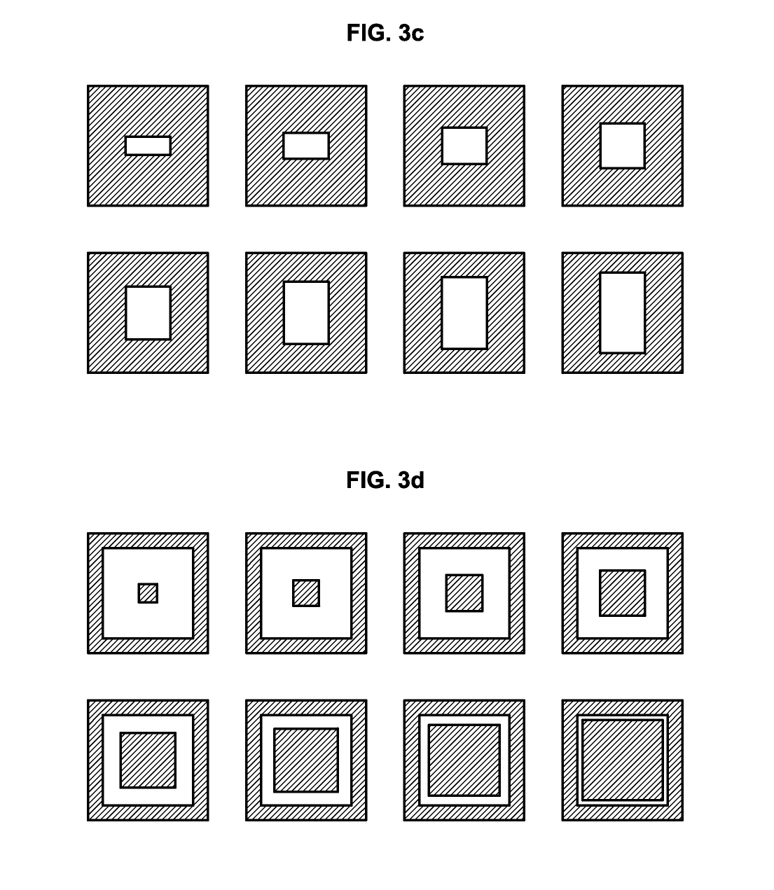

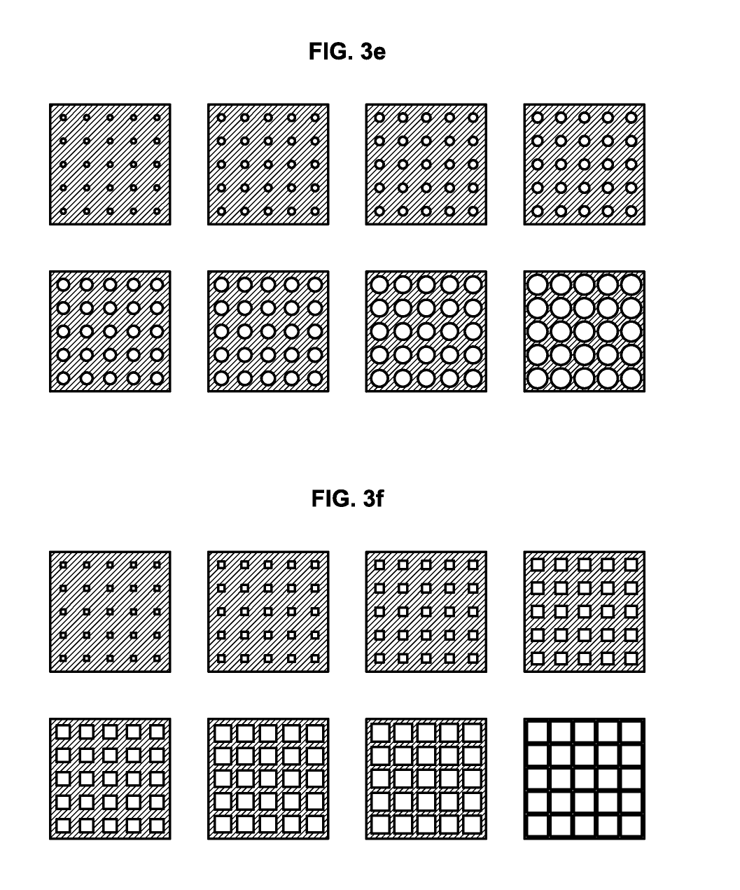

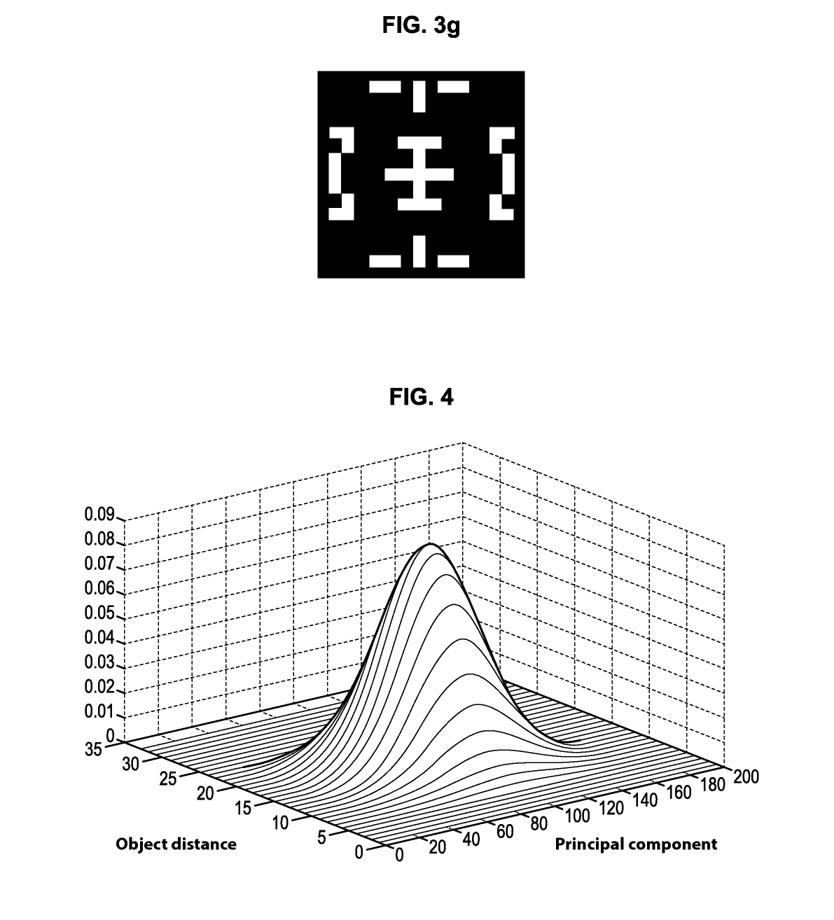

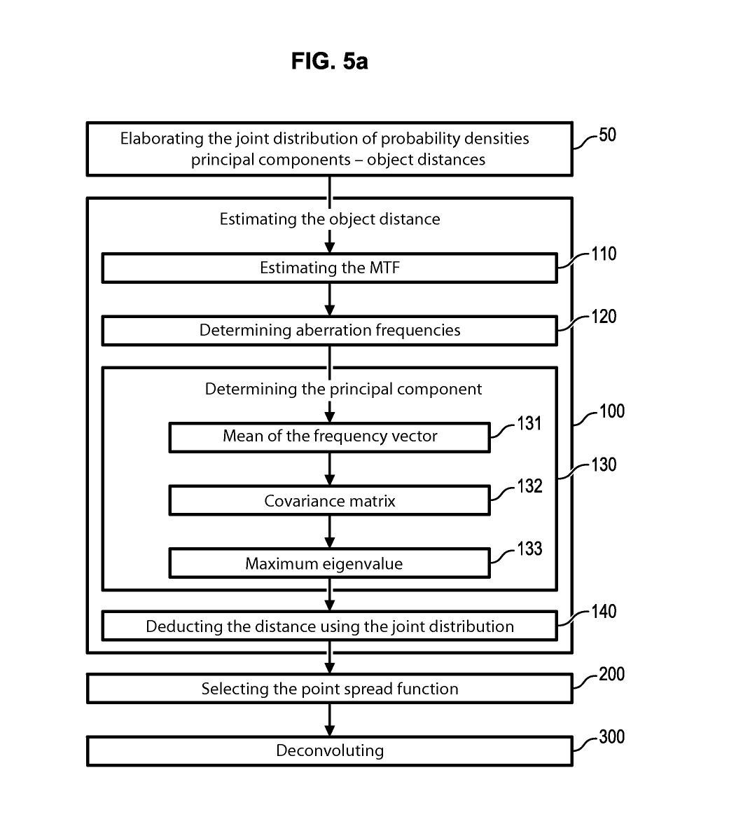

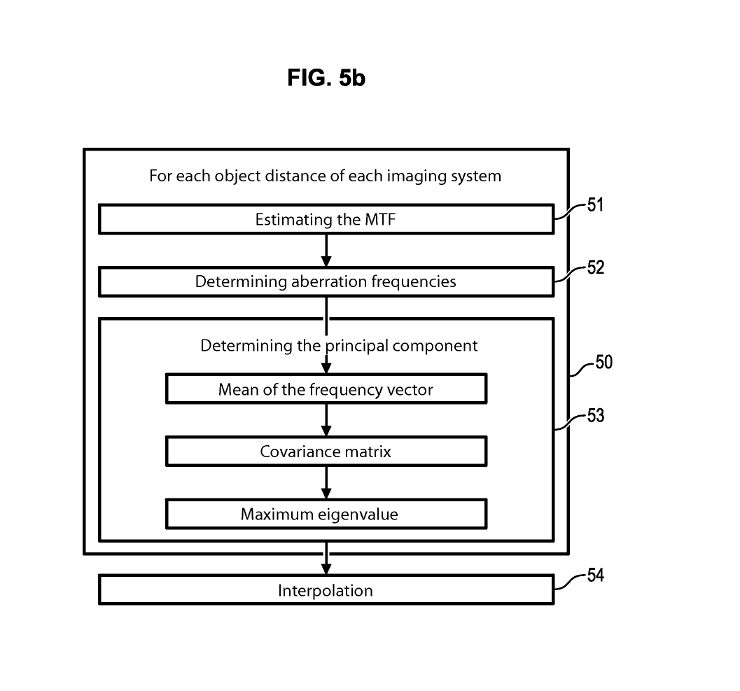

There now follows a description of a method for communicating a mobile transaction involving the abovementioned equipment, with reference to FIG. 2.

We will take the example of a user of the mobile terminal 2 who wishes to make a payment for an item of goods in a store in which the point of sale 1 is installed.

The user of the mobile terminal 2 moves his or her mobile terminal past the point of sale 1, in proximity to it.

A first near field communication channel C1 is established between the communication interface 11 of the point of sale 1 and the communication interface 21 of the mobile terminal 2 (step 101).

The processing unit 10 of the point of sale 1 initiates an electronic transaction by generating a message such as an APDU command (“Application Protocol Data Unit” described in the standard ISO 7816 part 4). The communication interface 11 sends the APDU command along the established channel C1 (step 102).

The processing unit 10 further stores in the storage means 14 a unique identifier contained in the APDU command sent. Provision can be made for a single identifier not to be stored in the storage means 14.

When the terminal 2 receives the APDU command via its communication interface 21 (step 103), this interface transfers this APDU command to the processing unit 20.

The high-level application executed by the processing unit 20 then verifies whether or not a connection to the network R of the terminal 2 via its interface 22 is available (step 104).

In the present text, it is considered that a connection to the network R is “available” if data can be communicated by the terminal 2 to the server 3, in other words, if the mobile terminal has previously established a main communication channel C2 with the network R capable of transporting data to/from the server 3.

If the connection is declared available, then the high-level application executed by the processing unit 20 converts the APDU command into a command, known as a “check command”, capable of being processed by the transaction server 3. This conversion can be implemented by means of security tokens pre-stored by the mobile terminal 2, by methods known in the prior art (the form of the commands and replies are described in the standard EMV, for the case of a payment transaction).

The high-level application commands the sending via the interface 22 of the check command obtained following the conversion of the APDU command received from the point of sale 1 (step 105).

After travelling over the main channel C2, the control command is received by the communication interface 32 of the authentication server 3 (step 111). The check command is then transferred to the processing unit 30 which controls/authenticates/validates the transaction initiated by the point of sale 1 using this command (step 112).

response to the check command, the processing unit 30 sends a check reply which follows a reverse path all the way to the mobile terminal 2, i.e. this response travels successively via the interface 32, the channel C4, the interface 22, the processing unit 10, the interfaces 13 and 23, and the processing unit 20.

The processing unit 20 converts the check reply into an APDU reply with the point of sale 1 as recipient.

This APDU reply then travels via the interfaces 21, the channel C1 and the interface 11 before reaching the processing unit 10 of the point of sale 1.

If a connection to the network R via the communication interface 22 of the mobile terminal 2 is declared unavailable by the processing unit 20, then the check command follows a different path. This scenario can typically happen when the mobile terminal 2 is outside the network coverage area of its network R access provider (no equipment of access point type is in proximity to the terminal 1) or the power of the signal for communicating data via the interface 22 is insufficient.

In this case, the processing unit 20 commands the establishment of a secondary communication channel C3 between the communication interfaces 23 of the mobile terminal 2 and 13 of the point of sale 1 (step 106), unless the secondary channel C3 has not been already created.

Preferably, the opening of this secondary channel C3 relies on a strong authentication of the point of sale 1. From that point the channel thus created serves to transport the enciphered command, which would normally have travelled via the mobile connection by the interface 22.

The processing unit 20 then transmits the APDU command that it has received along the channel C3 thus established by the communication interface 23 (step 107).

The command is then received by the communication interface 13 which again transmits this command to the processing unit 10.

The processing unit 10 verifies that the transaction data received via the third channel C3 has previously been sent by the point of sale along the first channel C1 (step 109), before the point of sale 1 transmits said data to the access network via the interface 12 (step 110).

For example, this can be the processing unit 10 seeking to find out whether the identifier contained in the APDU command received from the channel 3 is present in the storage means 14.

If the identifier received is found in the storage means 14, this means that the command received from the channel C3 corresponds to a command previously sent over the channel C1. In this case, the processing unit 10 transmits the APDU command over the communication interface 12 of the point of sale 1 (step 110).

It is also possible to make provision for the storage of the unique identifier in the storage means 14 to be temporary: thus, if no unique identifier is received by the point of sale from the channel 13 within a predetermined time period, it is considered that the terminal 2 has not correctly relayed the APDU command, and an error message can be generated, or even displayed on a screen of the point of sale 1, prompting the user to make a new transaction by means of his or her mobile terminal 2.

The APDU command then arrives at a communication interface 32 of the transaction server via the channel C4 different to the channel C2 (step 111). The APDU command has therefore been able to arrive at the transaction server 3 even when the mobile terminal did not have access to a direct connection to the network R, and finally to the server 3.

If the identifier received from the channel C3 is not found in the storage means 14, the command is not transmitted over the channel C4 by the point of sale 1.

The processing implemented by the server 3 is identical to that described previously, with the exception that the replies generated by the processing unit 30 travel via the interfaces 32, 12, 13, 23, 21, 11 and the channels C4, C3 and C1 before arriving at the point of sale 1.

Verification can also be implemented by the access point during this return journey. To do this, the point of sale 1 stores a unique identifier of the response received via the channel C4 in the storage means 14.

If no command has been received by the point of sale via the interface 11 within a predetermined time period, this means that the response has not been correctly processed by the mobile terminal 2.

In the embodiment shown above, the APDU command is redirected by the mobile terminal 2 to the interface 23 instead of the interface 22 when it is not possible to send data over this interface 22 (the connection is not available, to repeat the terminology chosen previously.)

However, it is also possible to consider routing the APDU command to the interface 23 on the basis of other criteria, for example a geolocation criterion, assuming that the terminal possesses a receiver making it possible to determine its geographical position (GPS/GNSS).

If the geographical position determined by the receiver of the terminal 2 indicates that the mobile terminal is abroad, it is very probable that the main communication channel 2 is passing through a roaming network imposing a communication surcharge to the user of the mobile terminal.

It is therefore advantageous to redirect the APDU command to the interface 23 so that this command is finally relayed to the transaction server 3, even if the communication channel C2 is capable of transporting data, to avoid such a surcharge.

As indicated previously, the channels C1 and C3 can form a single channel in bi-directional near field; these two channels are in this case established simultaneously. This offers the advantage of requiring a minimum of modification of the components of the mobile terminal and the point of sale to implement this method (no additional interface is then required to ensure the transmission of the transaction data via channel C3).

In a variant, the interfaces 23 and 13 can be of WiFi type, which offers the advantage of allowing a wider communication bandwidth than NFC or Bluetooth®.

The preceding steps of the method can be implemented by means of two computer programs, one embedded in the mobile terminal (2), and the other in the point of sale (1).

1. A method for communicating an electronic transaction between a point of sale (1) and a transaction server (3) by way of a mobile terminal (2), the mobile terminal (2) being capable of connecting via an access network (R) for accessing the transaction server (3) via a main communication channel (C2), said method comprising the following steps carried out by the mobile terminal (2):
establishing (101) a near field communication channel (C1) with the point of sale (1),
producing (103) transaction data intended for the transaction server (3) on the basis of data transmitted by said channel (C1),
verifying (104) the availability of the main channel (C2),
if said main channel (C2) is unavailable, sending (107) the produced transaction data along a secondary channel (C3) established with the point of sale so that the point of sale (1) can transmit the data to the access network (R).

2. The method according to claim 1, wherein, the main channel (C2) being a cellular channel, the mobile terminal (2) determines its geographical position and selectively sends transaction data received along the main channel (C2) or a secondary channel (C3) established with the point of sale (1), according to its geographical position.

3. The method according to claim 1, characterized in that it comprises the following steps implemented by the point of sale (1):
establishing (101) the near field communication channel (C1) with the mobile terminal (2),
sending (102) primary transaction data in said channel (C1),
establishing (106) a secondary communication channel (C3) with the mobile terminal (2),
receiving, via said secondary channel (C3), secondary transaction data produced and sent by the mobile terminal (2) in response to the primary transaction data,
sending (110) secondary transaction data received along a channel (C4) pre-established between the point of sale (1) and the access network (R), said channel (C4) being independent of the mobile terminal (2).

4. The method according to claim 3, further comprising verifying (109) the secondary transaction data received via the secondary channel (C3) and produced beforehand by the mobile terminal (2), the sending of data in the channel (C4) pre-established between the point of sale (1) and the access network (R) being conditional on the result of the verification.

5. The method according to claim 1, wherein the two channels (C1, C3) established between the mobile terminal (2) and the point of sale (1) are of near field type.

6. The method according to claim 1, wherein the two channels (C1, C3) between the mobile terminal (2) and the point of sale (1) are established simultaneously and form a bi-directional channel.

7. The method according to claim 1, wherein the secondary channel (C3) established between the mobile terminal (2) and the point of sale (1) is of WiFi type.

8. A mobile terminal (2) comprising:
a first communication interface (21) capable of establishing a near field communication channel (C1) with a point of sale (1),
a second wireless communication interface (22) capable of establishing a main communication channel (C2) with an access network (R) for accessing a transaction server (3),
a third communication interface (23) capable of establishing a secondary communication channel (C3) with the point of sale (1),
a unit (20) for processing electronic transaction data configured to:
produce transaction data on the basis of data received by the first interface (21),
verify the availability of the main channel (C2),
if the second channel (C2) is unavailable, send the transaction data produced to the third interface (23) for the purpose of being transmitted by the point of sale (1) to the access network (R).

9. A point of sale (1) comprising:
a first communication interface (11) capable of establishing a near field communication channel (C1) with a mobile terminal (2),
a second communication interface (12) capable of establishing a communication channel (C4) with an access network (R) for accessing a transaction server (3),
a third communication interface (13) capable of establishing a secondary communication channel (C3) with the mobile terminal (2),
a data processing unit (10) configured to transmit electronic transaction data intended for the transaction server (3) sent via the first interface (11), then received in return via the second interface (12), to the third interface (13).

10. A device (1, 2) according to claim 8, wherein the third communication interface (12, 22) is of near field type.

11. A computer program product comprising code instructions for executing the steps of a method according to claim 1, when this program product is executed by a mobile terminal (2).

12. A computer program product comprising code instructions for executing the steps of a method according to claim 3, when this program product is executed by a point of sale (1).
